(19) United States
(12) Patent Application Publication
(10) Pub. No.: US 2001/0018670 A1
(43) Pub. Date: Aug. 30, 2001

(54) Method and system for efficiently transacting an order and for communicating order information between a construction contractor and a construction material supplier

(76) Inventors: Man Ee Tan, Singapore (SG); Lian Hup Low, Singapore (SG); Choon Huay Tok, Singapore (SG)

Correspondence Address: COLUMBIA IP LAW GROUP, PC, 4900 SW MEADOWS ROAD, SUITE 109, LAKE OSWEGO, OR, 97035, US

(21) Appl. No.: 09/792,907

(22) Filed: Feb. 23, 2001

(30) Foreign Application Priority Data
Feb. 26, 2000 (SG) 200001066-0
Jun. 21, 2000 (SG) 200003487-6

(51) Int. Cl. G06F 17/60

(52) U.S. Cl. 705/26

(57) ABSTRACT

To efficiently transact an order for construction material between a construction contractor and a construction material supplier using the present system, the server system is provided with a soft copy of construction drawings, each of the construction drawings containing a plan layout showing a type and location of structural elements in readable text, and a table listing the structural elements and the structural elements' corresponding specification also in readable text. Using the quantity extractor, the quantity information for the order is automatically extracted from the drawings. The extracted quantity information is then provided to the dient system in an order requisition preferably on a Web page. The dient system is then provided an option to accept the order requisition.

### FIELD OF THE INVENTION

The present invention relates generally to a method and system for transacting an order between a construction contractor and a construction material supplier.

### BACKGROUND OF THE INVENTION

Construction materials such as steel bars are critical in the construction industry as they are one of the fundamental components of any construction project. A construction project is usually managed by a construction contractor.

Typically, a construction contractor is responsible for buying construction materials from various suppliers. A supplier may supply the material only or also provide the service of fabricating the product per the need of the specific part of a project for which the product order is intended. The contractor provides the specification of the products needed which include type of metal, size, shape, quantity, etc. The contractor also provides a deadline for which the construction products must be delivered to a specified site.

For relatively large projects, not all quantities of the products needed for the entire project are requested by the contractor to be delivered at one time. Typically, a schedule of delivery is set such that a specified set of goods are delivered in a manner which corresponds to the schedule of the project. A project to build a large condominium complex, for instance, may base the materials delivery schedule on the completion of each floor of the building. It is a customary practice for the contractor to be paid on an incremental basis as the project is being completed. Similarly, the supplier is also paid as and when the deliveries are made and after the documentation of the deliveries are properly verified by the contractor. Currently, there is no systematic method or system for verifying the deliveries. Hence, it is not unusual for the contractor to have long delays in making payments to the supplier, even when the deliveries have been correctly and promptly made.

It is critical to the construction project that the supplier deliver the construction materials per the contractor's specification. If a wrong type of product not suitable for the project is inadvertently delivered, the product must be sent back and the correct product must be redelivered. Because the supplier of the prefabricated products always requires some time to fabricate the goods per the customer's specification, a wrong delivery will inevitably cause delays to the entire project. Meeting the deadline of any order is absolutely critical if the construction project is to meet its scheduled completion date. Unfortunately, it is all too common in the industry to have many delays due to the failure of the supplier to deliver the ordered good in a timely manner. The reasons for the failure are many, not all of which are the fault of the supplier alone.

A wrong delivery can adversely affect the supplier as well. Aside from the obvious downside in damaging the supplier's general reputation, a wrong delivery can cause great financial damage in certain instances. For example, in some cases, a wrongly-delivered product may still be used by the contractor if the specification of the delivered good exceeds what was required for the project. For instance, the wrongly-delivered steel bars may be thicker, and hence, stronger than what was required. In such instances, the contractor may still choose to accept the delivery so as not to delay the project, but without offering to pay additional fee for the more expensive product (a thicker bar requires more steel, and hence, is more expensive than a thinner bar of comparable quality). After all, it was not what the contractor had ordered. Inevitably, the supplier must agree. Because steel product trade (as well as other construction material trade) is a very low margin business, such a concession can actually lead to a net loss for that transaction.

Currently, the way the construction contractor makes an order from the construction supplier can broadly be viewed as being manual. A typical way that a contractor orders construction material supplies from a supplier is to deliver to the supplier a set of structural drawings for a project or set of projects. Using the drawings, the supplier has the responsibility of extracting out the quantity information for the various components of a project. The quantity information for a steel supplier, for instance, may include the type of steel, shape, size, number of pieces, etc. Currently, the quantity information is manually extracted from the drawings, that is, a person must physically read the drawings and tediously record the information. This is an inefficient way to obtain the quantity information. For one, it requires special knowledge about construction drawings. In addition, it is time-consuming and is prone to human error. Although it can be seen that a better system is needed, currently, no system is able to perform the above functions automatically.

Once the quantity information is extracted, it is kept by the supplier to be used until an order is placed by the contractor. Because the contractor typically orders the components on a piecemeal basis corresponding to the project schedule, ideally, the quantity information should also be correlated to the project schedule. For instance, the order may for the steel components for the first two floors of a multi-story building. The quantity information should be organized such that the components corresponding only to the first two floors can easily be determined such that the order can be filled properly. Currently, although each order is documented, there is no automatic way of documenting each transaction in relation to the overall quantity information, and an easy way to communicate the information to the contractor. Furthermore, the process of tracing the order documents can be a tedious and time-consuming process, and so information such as consolidated quantities is hard to come by. Many of the delays in the delivery of ordered goods as well as other problems, some of which have been mentioned above, can be traced one way or another to the current method of obtaining quantity information, and the current method of transacting and documenting an order between the contractor and the supplier.

### SUMMARY OF THE INVENTION

The present invention allows the contractor to order construction material from the supplier over the Internet using the World Wide Web (or “Web”) via the contractor system, or client system, and the steel product supplier system, or the server system. The present invention also allows automatic extraction of quantity information from construction drawings that are supplied by the contractor. The present invention further allows the contractor to view the extracted quantities as well as other information to assist him in making the orders from the supplier.

The server system includes a server engine, a client ID/customer/password table, various Web pages, a quantity extractor, a customer database, a order database, a consolidated quantities database, quantities extractor, extracted quantities database and a progress database. The server engine receives HTTP requests to access Web pages identified by URLs and provides the Web pages to the client system. The client ID/customer/password table contains the mapping of the client ID to the correct contractor and its corresponding password. The customer database contains the particulars of all the contractors being serviced by the supplier. The order database contains the order information for each of the contractors including the updated status of each the deliveries. There will also be options to allow the contractor to make changes to the orders provided that the changes are made within the specified period. The consolidated quantities database contains the consolidated quantities of all of the orders. The progress database contains the project schedules and the delivery schedules of the various construction projects. The quantities extractor allows relevant quantities information to be automatically extracted from the construction drawings, and stores the information in the extracted quantities database.

The client system includes a browser which is used to access the Web pages of the server system. By accessing the various Web pages, the contractor is able to access up-to-date status of the orders, the progress of the project and deliveries. Each contractor is assigned a unique client ID and a password which are needed to access the product supplier's web site. In the preferred embodiment, the client system also includes a project management system which the contractor uses to create and modify project schedules. In the preferred embodiment, the project management system of the clients system is linked to the server system such that the project schedules are directly imported into the progress database of the server system to provide an up-to-date information about the progress of the project. By linking the server system with the project management system of the client's system, the supplier is able to obtain all of the necessary project schedule information including any modification which occur during the duration of the project.

To efficiently transact an order for construction material between a construction contractor and a construction material supplier using the present system, the server system is provided with a soft copy of construction drawings, each of the construction drawings containing a plan layout showing a type and location of structural elements in readable text, and a table listing the structural elements and the structural elements' corresponding specification also in readable text. Using the quantity extractor, the quantity information for the order is automatically extracted from the drawings. The extracted quantity information is then provided to the client system in an order requisition preferably on a Web page. The client system is then provided an option to accept the order requisition. Alternatively, the client system can be provided with an additional option to modify the quantity information before accepting.

The method of automatically extracting quantity information for the order comprises the following steps: opening the construction drawing and selecting the table in the construction drawing; searching the table based on a predetermined set of guidelines and reading the text corresponding to the structural elements and structural elements' corresponding specification; interpreting the text based on a pre-determined set of rules to calculate the quantity information for the structural elements; selecting the plan layout in the construction drawing; searching the plan layout and reading the text marking the structural elements; and calculating the quantity information for the order using the quantity information and the text marking the structural elements. While this method of quantity extraction is best employed in a client/server system such as the one described herein, it may be employed in any computer system.

### BRIEF DESCRIPTION OF THE DRAWINGS

FIG. 1 is a symbolic diagram illustrating the relationship among the various parties involved in a construction project.

FIG. 2 is a block diagram illustrating the preferred embodiment of the present invention.

FIG. 3 shows the server system's Web page where the contractor can enter its UserID an Password to access server system's Web pages.

FIG. 4a and FIG. 4b show the server system's order status Web pages.

FIG. 5 show the server system's progress Web pages.

FIG. 6 show the server system's consolidated quantity report Web page.

FIG. 7 illustrates a Column Schedule Table which lists the details of the columns needed.

FIG. 8. illustrates a floor layout which shows the locations of the columns.

FIG. 9 illustrates the process of selecting a table from a structural drawing during the initialisation stage of the quantity extraction process.

FIG. 10 illustrates the process of searching and reading the relevant text from the table shown in FIG. 9 during the initialisation stage of the quantity extraction process.

FIG. 11 illustrates the process of selecting a floor layout from a structural drawing during the second stage of the quantity extraction process.

FIG. 12 illustrates the process of searching and reading the relevant text from the plan layout shown in FIG. 10 during the second stage of the quantity extraction process.

FIG. 13 illustrates a sample page displaying the extracted quantities after the initialisation process.

FIG. 14 illustrates a sample page displaying an order requisition after all of the relevant quantities have been extracted.

FIG. 15 illustrates a sample page displaying the details of an order.

FIG. 16 is a block diagram illustrating the alternative embodiment of the present invention

### DETAILED DESCRIPTION OF THE INVENTION

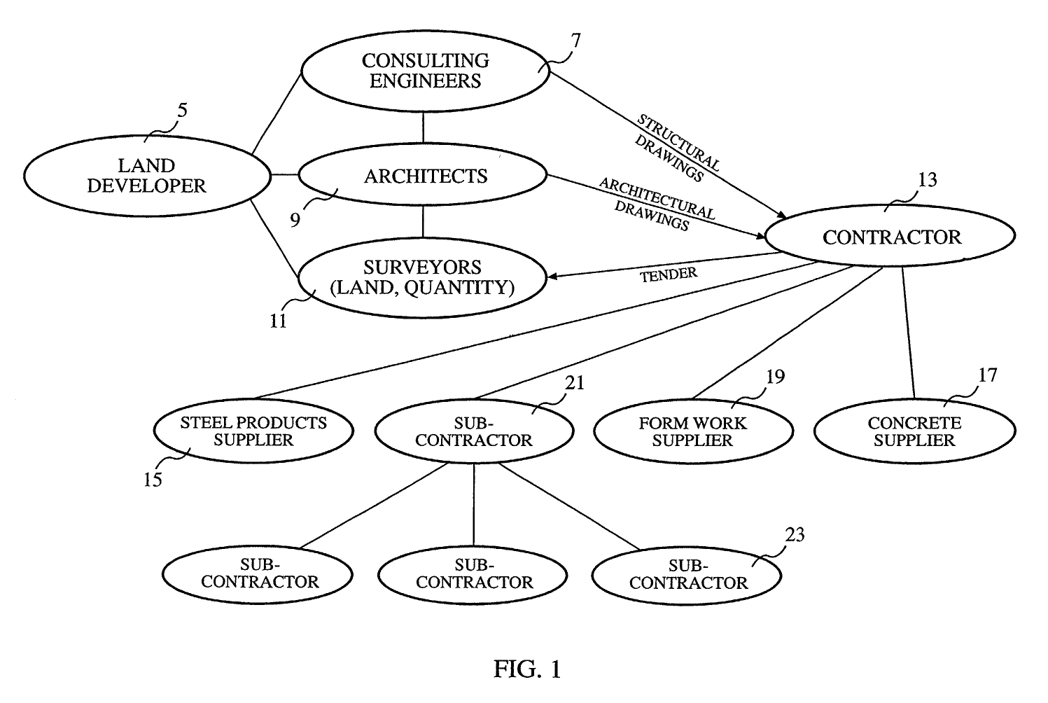

FIG. 1 illustrates a diagram which depicts the relationship among the main parties involved in a construction project. In order to provide a dear description of the preferred embodiment of the present invention, references will be made to supplier of steel products rather than referring to a supplier of construction materials in general. However, it should be understood, the reference to steel products is illustrative only, and should not be taken as a limitation to the present invention.

Referring to FIG. 1, typically, a construction project is initiated and funded by a land developer 5. In preparation for the project, the land developer hires a team of consulting engineers 7, architects 9, and quantity surveyors 11. The main role of the consulting engineers 7 is to design the structure and generate a set of structural drawings for the project. The main role of the architects is to generate a set of architectural drawings for the project. The main role of the quantity surveyors is to deal with contractual matters and also to quantify the project.

The structural and architectural drawings are then provided to various contractors who tender for the project through the quantity surveyors. The developer 5 then chooses the contractor based on the submitted tenders and other factors. The chosen contractor 13 then coordinates the construction of the project by hiring various suppliers of structural goods such as the steel product supplier 15, concrete supplier 17, and the form work supplier 19. The contractor 13 also may hire various sub-contractors 21 to install the materials delivered who may in turn hire additional sub-contractors 23 of its own.

As alluded to above, on a construction project, the delivery schedule of the steel products is largely determined by the schedule of project. The contractor 13 relies on the structural and architectural drawings and experience to set the project schedule. The contractor typically informs the supplier 15 of both the project schedule and the delivery schedule. The supplier correspondingly relies on the schedules provided by the contractor 13 to provide and fabricate the steel products and to make the deliveries.

The steel supplier 15 usually supplies to many projects, and hence, the delivery schedule provided by the contractor 13 in one particular project is one of many that the supplier must follow. Because each delivery requires allocation of resources which are limited, it is imperative that the supplier plan ahead for each of the deliveries. The supplier's ability to deliver the ordered products is determined by the availability of three main factors: raw material, machine capacity, and manpower. The raw material, e.g., steel bars, are obviously required before the product can be made. But even if the material is available, sufficient machine capacity and manpower are required to fabricate the products which entail shaping the material to conform to the contractors specification. Therefore, the steel product suppliers in general have certain predetermined lead time for any deliveries to be made. When the supplier 15 accepts a delivery schedule from a contractor, it plans for the delivery taking into account the lead time for each delivery to be made. In calculating the lead time, it is important for the supplier 13 to take into account the deliveries to be made for the other projects as well.

The deliveries can usually be made without any problems so long as the contractor 13 keeps to the original delivery schedule, or informs the supplier of any changes. The changes in the original schedule can come about for many reasons. For instance, one common reason is a change initiated by the developer where it wants to make modifications to the original structural drawings. In other instances, the changes may come about due to an error in the original drawings which are only later discovered. The changes can come from the contractor 13 as well where the change is caused by a delay in work done by the sub-contractors on site, or other contingencies not within the control of the contractor such as bad weather.

The current method which can be deemed as “manual” does not adequately address the situations where changes are made to the original quantities or schedule. The “manual” method uses verbal and/or written communications delivered via the telephone, mail, fax or via the electronic means such as e-mail. Such communications are received, dealt with and filed away in a way without any relation to the supplier or to the progress of the contractor's site. This “manual” method relies on the diligence and memory of the operating personnel to communicate changes without any possibilities for reminders. Often times, the supplier is not informed of the changes in the plan, or are not informed until it is very late. Even when the information may have been relayed to the supplier, it may be processed incorrectly by the supplier due to absence of any system for handling such issues.

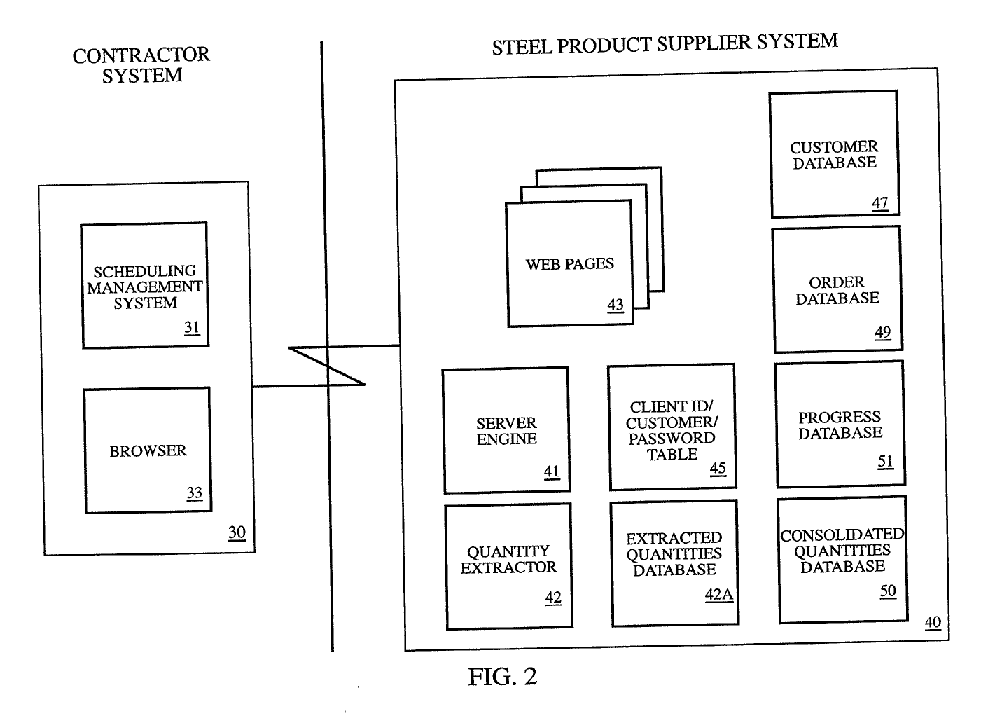

FIG. 2 is a block diagram illustrating the preferred embodiment of the present invention. This embodiment allows the contractor 13 to order construction material from the supplier 15 over the Internet using the World Wide Web (or “Web”) via the contractor system 30, or client system, and the steel product supplier system 40, or the server system. The present invention also allows automatic extraction of quantity information from construction drawings which is supplied by the contractor 13. The present invention further allows the contractor to view the extracted quantities as well as other information to assist him in making the orders from the supplier 15, and also allows him to make any changes as necessary.

The server system 40 includes a server engine 41, a client ID/customer/password table 45, various Web pages 43, a quantity extractor 42, a customer database 47, a order database 49, a consolidated quantities database, quantities extractor 42, and a progress database 51. The server engine 41 receives HTTP requests to access Web pages identified by URLs and provides the Web pages to the client system 30. The client ID/customer/password table 45 contains the mapping of the client ID to the correct contractor and its corresponding password. The customer database 47 contains the particulars of all the contractors being serviced by the supplier 15. The order database 49 contains the order information for each of the contractors including the updated status of each the deliveries. There will also be options to allow the contractor 13 to make changes to the orders provided that the changes are made within the specified period. The consolidated quantities database 50 contains the consolidated quantities of all of the orders. The progress database 51 contains the project schedules and the delivery schedules of the various construction projects. The quantities extractor 42 allows relevant quantities information to be automatically extracted from the construction drawings.

The client system 30 includes a browser 33 which is used to access the Web pages 43 of the server system 40. By accessing the various Web pages, the contractor 13 is able to access up-to-date status of the orders, the progress of the project and deliveries. Each contractor is assigned a unique client ID and a password which are needed to access the product supplier's web site. In the preferred embodiment, the client system 30 also includes a project management system 31 which the contractor 13 uses to create and modify project schedules. In the preferred embodiment, the project management system 31 of the clients system 30 is linked to the server system 40 such that the project schedules are directly imported into the progress database 51 of the server system 40 to provide an up-to-date information about the progress of the project. By linking the server system 40 with the project management system 31 of the client's system 30, the supplier 15 is able to obtain all of the necessary project schedule information including any modification which occur during the duration of the project.

One skilled in the art would appreciate that various communication channels may be utilised to facilitate the transaction between the contractor. For example, the local area network, wide area network, or point-to-point dial up connection may be used. Also, the server system may comprise any combination of hardware or software that can keep track of the schedules and scheduling changes. Moreover, although it is convenient to conceptually separate the various databases, e.g., customer database, it should be understood that all of the information may be stored in a single or other number of databases.

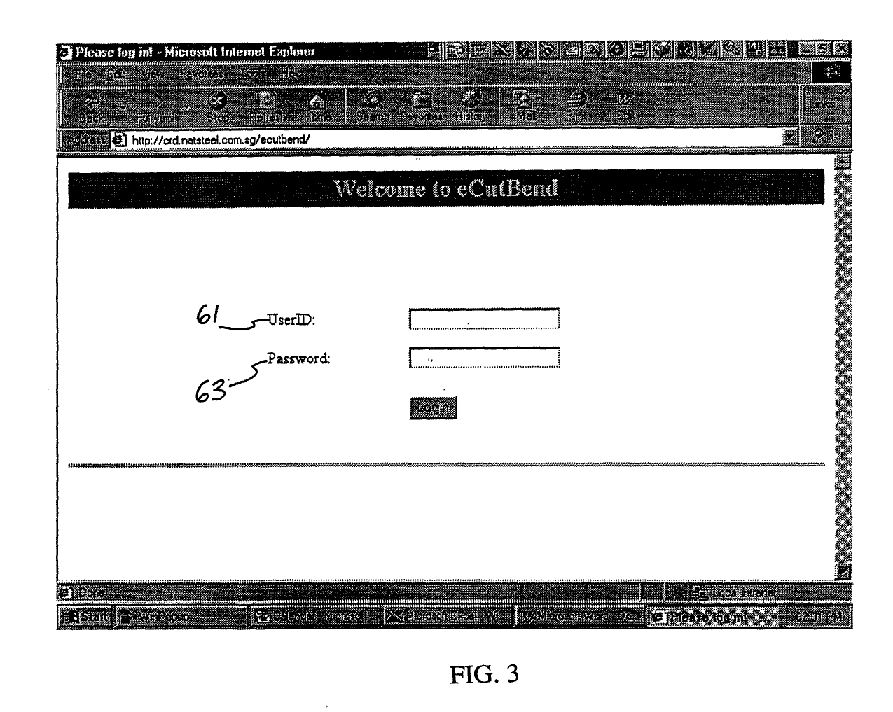

Through a communication network, the contractor 15 is able to obtain various valuable and up-to-date information from through the Web pages provided through the supplier web site. To access information from the server system 40, the contractor accesses the homepage of the server system's web site and enters its UserID and Password as shown in FIG. 3. Once the correct UserID and Password are entered, the contractor 15 is able to access, among others, the order status of any delivery and also the progress of the project.

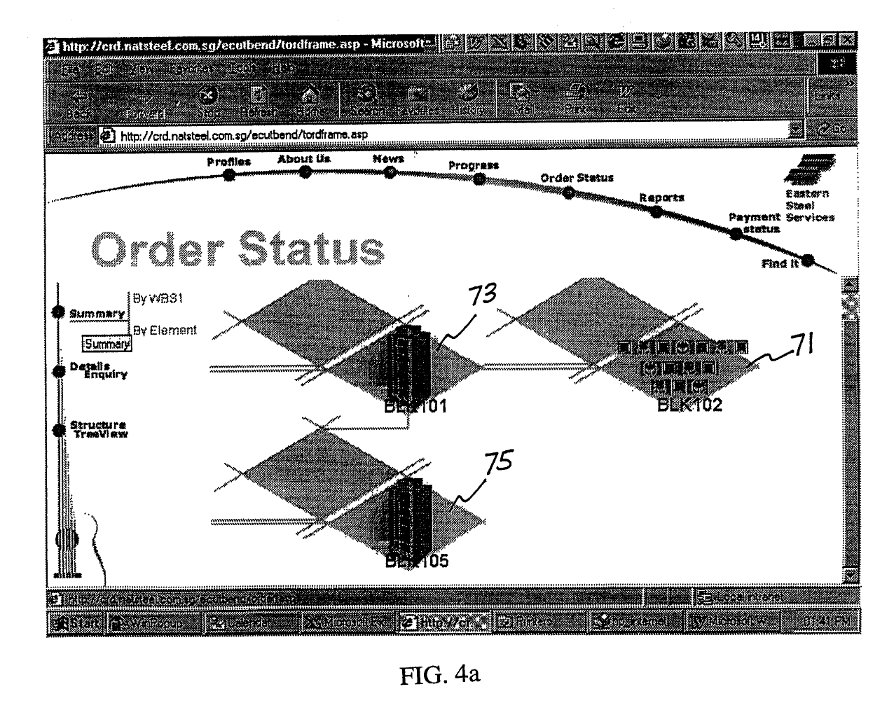

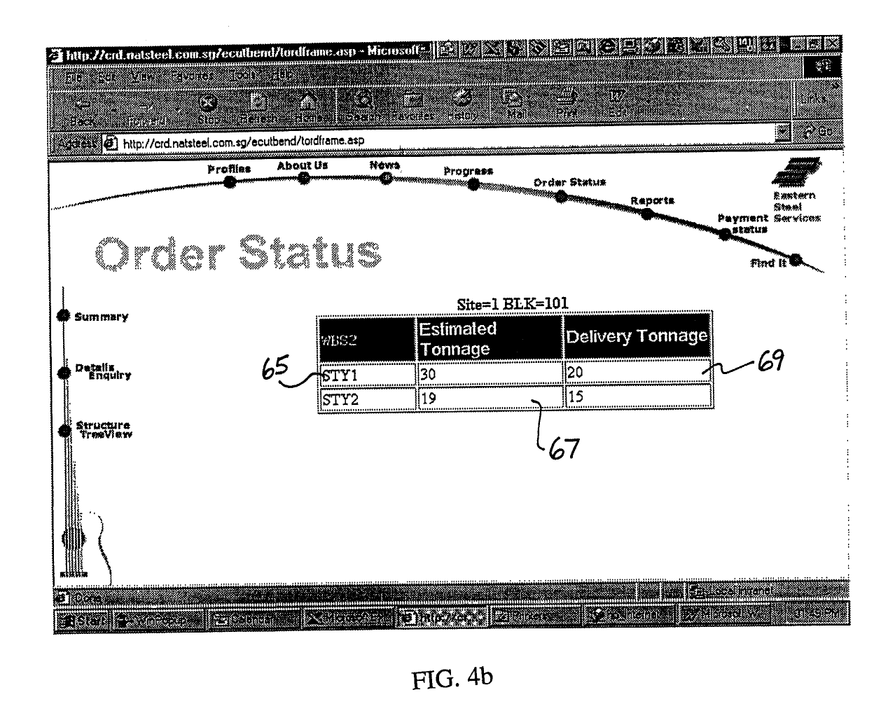

FIG. 4a and FIG. 4b illustrate some examples of what may be shown on the order status Web pages. As shown in FIG. 4a, the order status page may graphically show the various buildings built on a particular project with each of the buildings labeled with a block number. As can be seen, block 102, 71, which does not have a building picture like the blocks 101, 73, and 105, 75, indicating that the construction has not begun. When one selects a block where the construction has begun, e.g., block 101, a Web page like the one in FIG. 4b which provides the order status for that block is shown. As shown in FIG. 4b, the order status may indicate the building level 65, i.e., “STY1” meaning story 1, the estimated total tonnage of steel 67 required for that story, and the tonnage of steel delivered 69. Other order status Web pages can provide a schedule of deliveries to be made showing the intended delivery date, order details such as number of pieces, dimensions, shapes, type of product, and tonnage. It can also indicate whether each of the orders shown in the schedule can be modified. If an order is modified, then the corresponding change is made in the order database 49.

The order status pages provide great benefits to both the contractor and the supplier. By providing an up-to-date status of the order, the contractor can easily determine whether additional orders are required and make the necessary order. If on the other hand, further deliveries are not required, or other quantities or products are required, the contractor can immediately make the necessary changes. By providing timely prompts and reminders to make the orders, the contractor is almost always ensured that he will receive the products that it needs. The supplier also benefits since it is always promptly informed of the changes in the orders, so that proper preparation can be made.

Using the present system, the ordering of the steel products may be done by the contractor 13 or the supplier 15. By obtaining the project schedule of the project and necessary drawings, the supplier may suggest a delivery schedule to the contractor via the order status pages. The contractor can then choose to accept the order or make any necessary changes. Whether the initial order is prepared by the contractor 13 or the supplier 15, the order status pages allow both parties to be well informed.

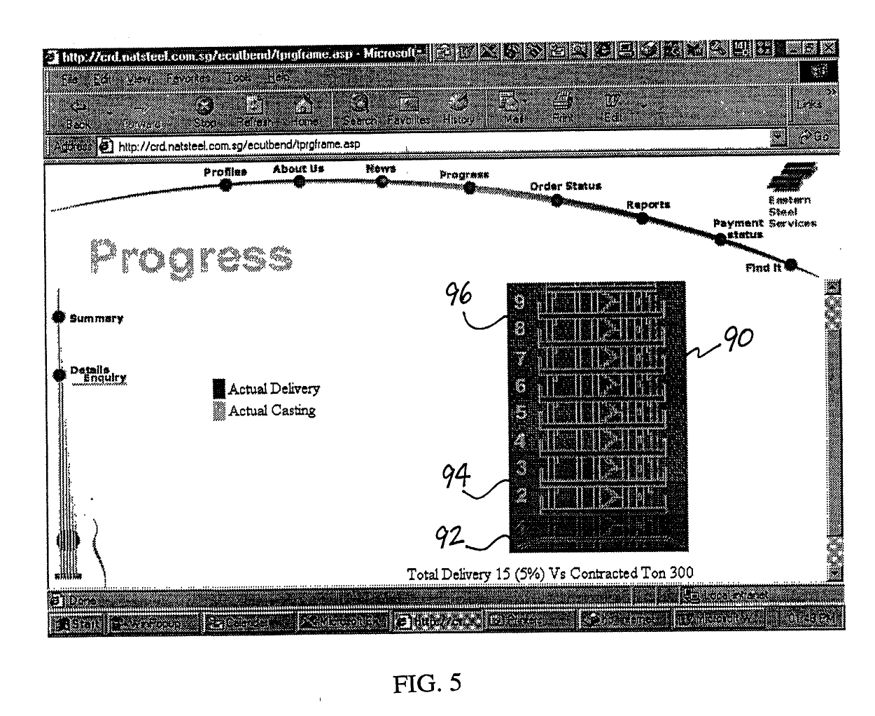

FIG. 5 illustrates an example of what may be shown on a progress Web page. The progress of the project can be indicated graphically as shown in FIG. 5 as a picture of a building 90 having the number of floors corresponding to the project. The darkened portion 92 (floor 1) indicates the portion of the project which has been casted and for which the steel product delivery has been made. The lighter portion 94 (floors 2 and 3) indicates the portion of the project which has been casted, but for which the steel product delivery has not been made. The lightest portion 96 (floors 4 though 9) indicates the portion of the project which has not been casted. If any change to the original project schedule is made, e.g., a change in casting date of 4th floor is needed, then the change would be effected on the progress page providing an update to both the contractor as well as the supplier. Adjustments in the orders can be made accordingly either by the contractor or the supplier.

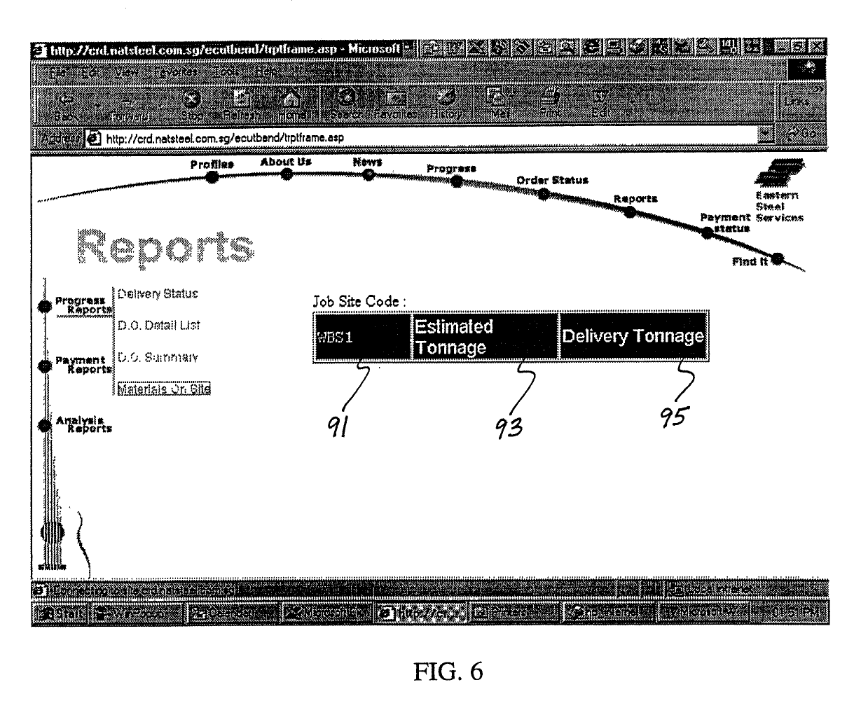

FIG. 6 illustrate an example of what may be shown on the consolidated quantities report Web page. As shown in FIG. 6, the Web page shows the Job Site Code 91, the estimated tonnage 93, and delivery tonnage 95. The Job Site Code 91 is simple a code assigned to a particular job site. The estimated tonnage 93 is the total tonnage of steel required for the site. The delivery tonnage 95 is the total tonnage delivered thus far for that site. The total tonnage delivered is the sum of the delivery tonnage 69 figures shown in FIG. 4b for that site. By providing a consolidated quantity figure for a particular site, the constructor is able to easily determine whether deliveries have been made without expending time and resources to determine the figure by manually summing up the figures from the order documents.

Now the process of automatically extracting quantity information shall be described. Before the contractor 13 places any order, it provides to the supplier 15 a soft copy of a complete set of structural drawings for which the quantity information is to be extracted. The drawings are preferably autocad drawings in the standard DWG or DXF format, but other formats are possible provided that the format is standardised. The drawings may be provided via various means. For instance, it may be sent to the supplier system 40 via the internet such as an attachment in an e-mail. Alternatively, it may be stored in a storage medium such as a diskette or a CD-ROM, and the storage medium can be sent by mail or hand delivered. The received drawings should be properly catalogued such that the contents of each drawing are readily available.

A typical structural drawing basically contains a floor plan diagram (also called plan layout) and a table of structural elements (though each may be represented in a variety of forms). The floor plan shows the layout of the structural elements and the table lists the corresponding structural elements which are needed for the layout shown in the floor plan. The structural elements are, for instance, beams or beam cages, pilecaps, columns, etc., all of which are well known to those in the construction industry. Each structural element, e.g., column, is made up of a plurality of steel bars, and depending on the type of column needed, a different set of bars are required.

To completely determine the steel bars needed for a column one needs the following basic specification: the width, length, and height of the column; the number of bars needed in the column; the type of steel of the bars; the bar diameter. One also needs the lap length of the column and the stirrup details, but these can be calculated using the basic information provided above. The length of the steel bars needed for a column is calculated as the height of the column plus the lap length of the column. The diameter, type of steel, and the number of the bars is provided in basic information. The bars needed for the stirrup can be determined using the width and length of the column and the concrete cover.

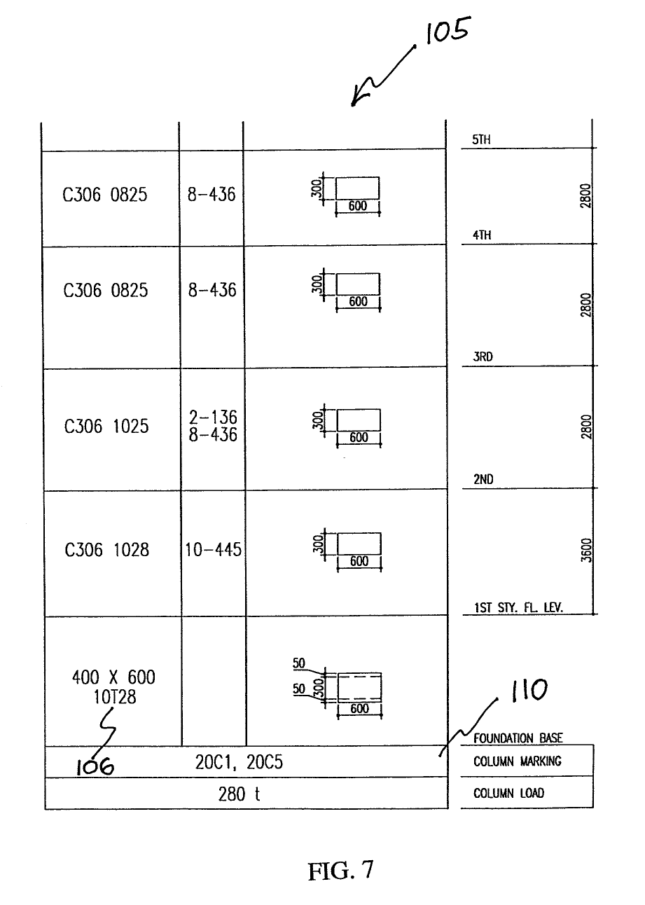

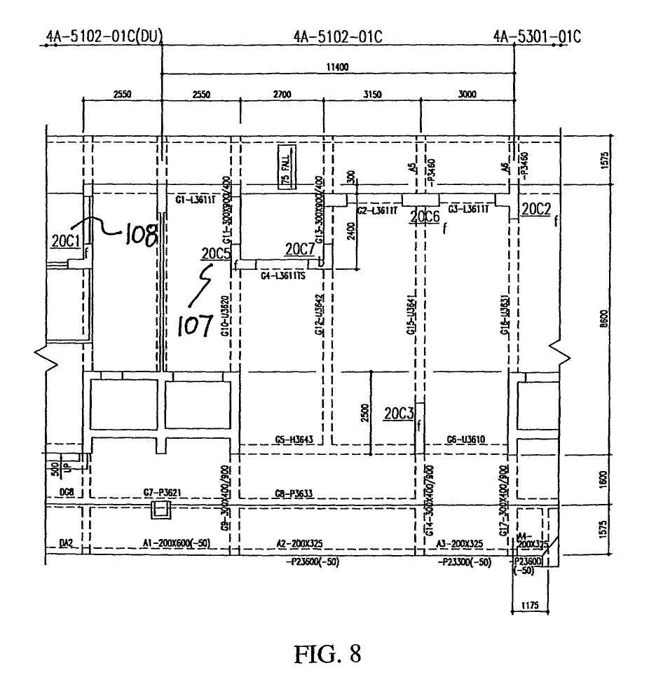

A sample table listing the column details is shown in FIG. 7 (only a portion of the table is shown) which illustrates a table 105 which lists column details. As shown, columns are identified by their marking 110, e.g., “20C1” (and also “20C5” in this case). Under the marking 20C1, the code “10T28” 106 indicates that the column has 10 bars (corresponding to the first number 10), that the steel type is tensile (corresponding to the letter “T”), and that the diameter of the bars in the column is 28 mm (corresponding to the number 28). The thickness of the column is shown here as 300 mm and the width is shown here as 600 mm. The floor height is given in other drawings. Thus all of the basic specification is provided, and the lap length and the stirrup details may be calculated. Using all of the information provided and calculated, the specific set of bars needed for the columns of the type 20C1 and 20C5 can be determined. A sample plan layout corresponding to the table of FIG. 7 is shown in FIG. 8. As can be seen, the layout of the column markings, e.g., “20C1” and “20C5”, are clearly indicated in readable text.

The quantity extractor 42 uses these structural drawings to automatically extract the necessary quantity information which is used during the ordering transaction. The quantity extraction process can broadly be viewed as having two stages. The first stage (also referred to as the initialisation stage) is where the quantity extractor extracts the type and number of steel bars needed for each type of each structural element from all of the tables provided in the structural drawings. This information then stored in the database 42A. The second stage is where the quantity information relating to a specific order is determined for a specific portion of the project (usually done on a floor-by-floor basis or a part thereof for which the order needs to be filled. The second stage is necessary because it is customary in the construction industry to have the contractor 13 order the needed material on a piecemeal basis based on the current schedule of the project.

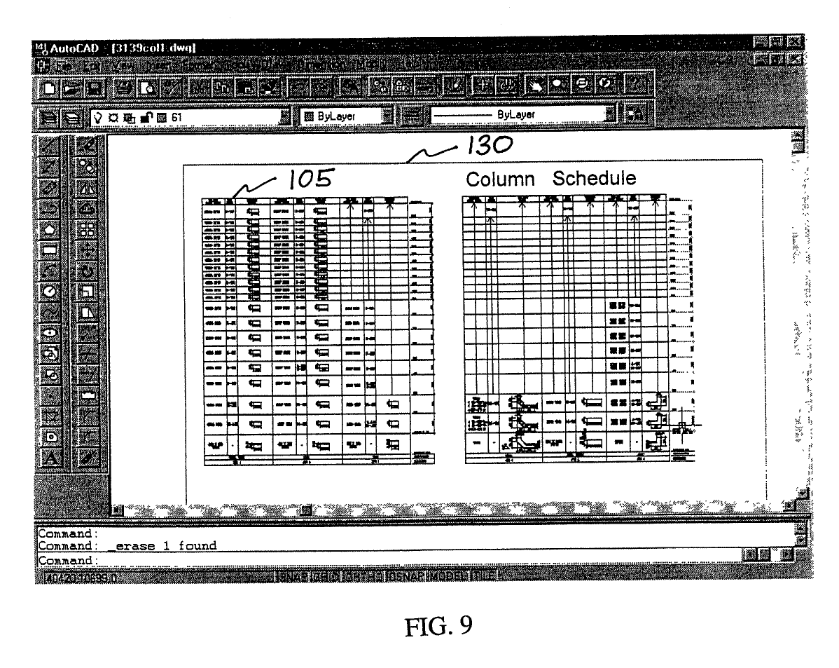

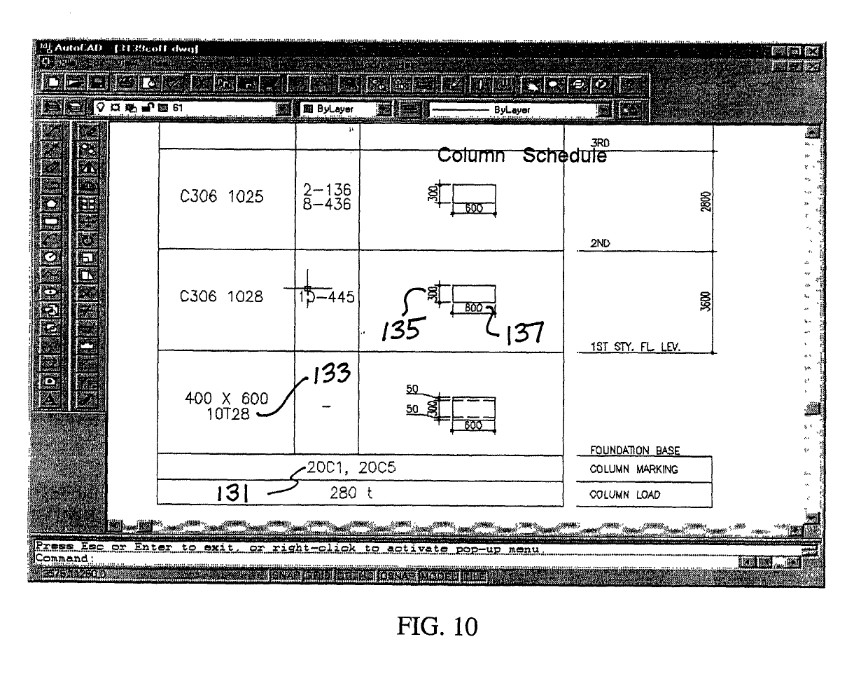

To begin the initialisation stage, the soft copy of a structural drawing is opened using the quantity extractor as shown in FIG. 9. The table(s) listing the structural elements is selected by delineating it within a box 130 (or by other methods for selecting). Because the format of the textual information is standardised, the quantity extractor 42 is able to search and record the relevant text corresponding to the basic specification. Of course, the quantity extractor 42 is provided with the structure and format of the table which may vary from table to table and from drawing to drawing. For instance, in the case of the column details shown in FIG. 10, the quantity extractor would search for the column marking which is in the format “20C1”, 131 and a corresponding code in the format “10T28”, 133. The length and the width of the column are read by searching the third column of each marling and reading the corresponding length, 135, and width, 137, information. This initialisation process is performed for all tables and other standard details from all of the structural drawings.

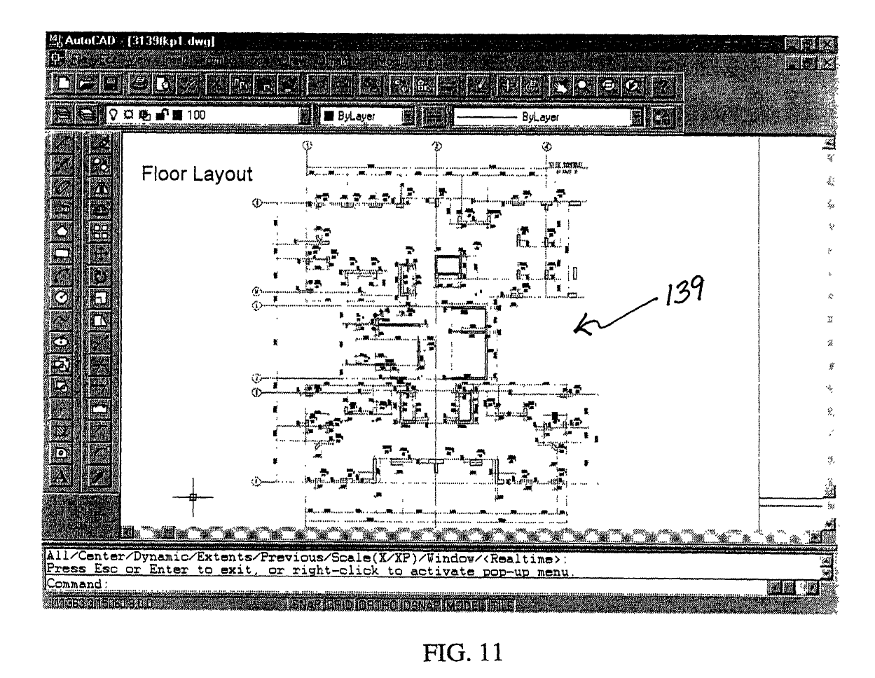

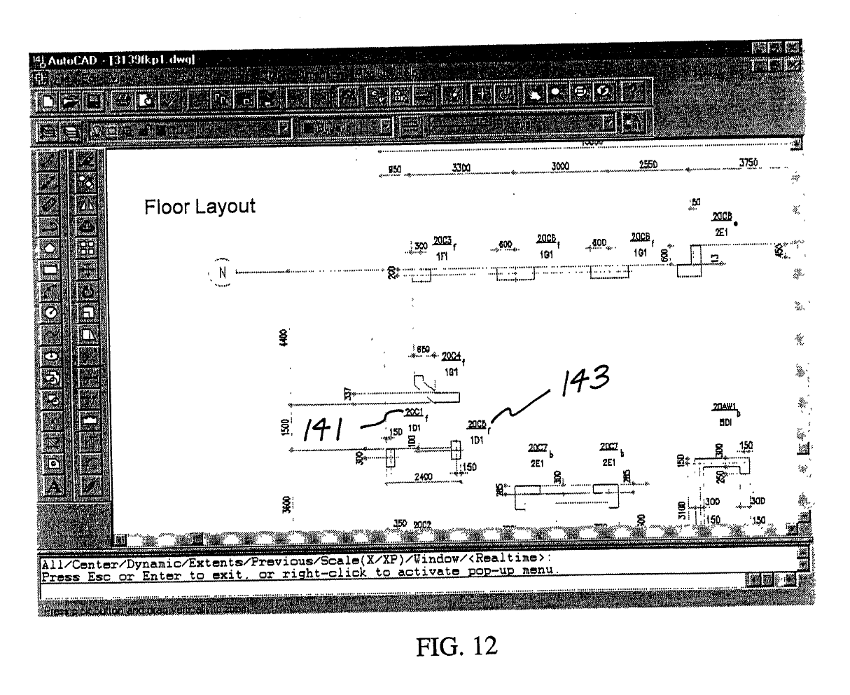

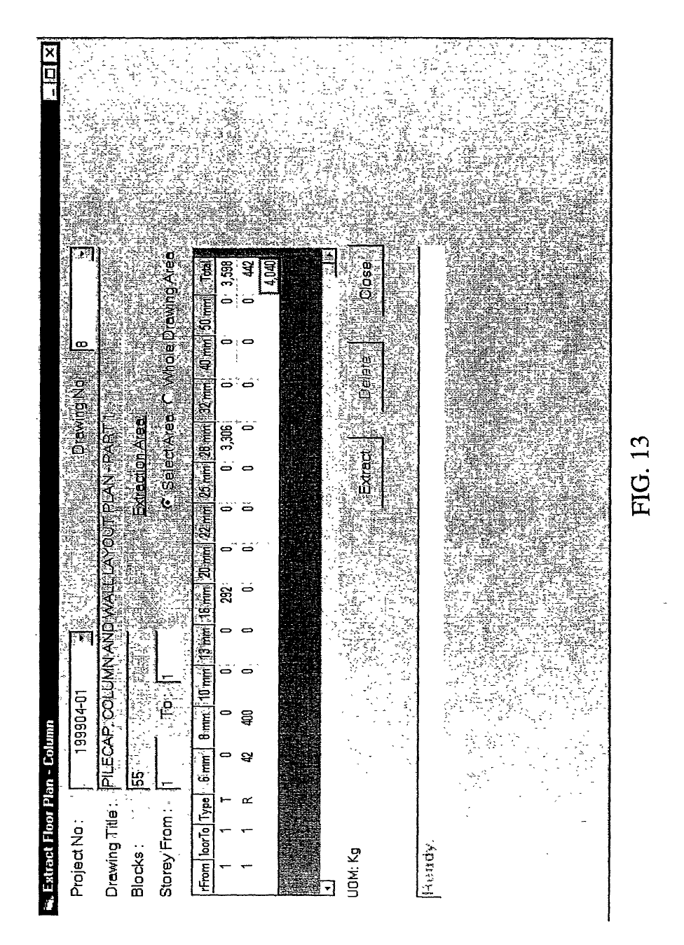

Once the initialisation process is completed, the quantity extractor 42 is now ready for the second stage which is to extract quantity information for a specific order transaction. The ordering for construction materials typically corresponds to the project schedule which typically is done on a floor-by-floor basis (or parts thereof) if the project involves the construction of a multi-story building. So for instance, if a contractor is about to complete the second floor of a multi-story building, the material for the next floor, i.e., third floor, needs to be ordered given a certain pre-determined lag time (so that there is no delay). To determine the quantity information for a particular floor or floors, as shown in FIG. 11, the quantity extractor 42 is used to open the structural drawings and select the floor plan layout 139 corresponding to the floor for which the order is to be made. Thereafter, the extraction process is initiated, and the quantity extractor 42 searches for all text corresponding to the marking for a particular structural element (in this case column markings) as shown in 12. So in this case, it would search and select “20C1”, 141, “20C5”, 143, etc. until all text having the format of a marking is found. Once all of the markings have been extracted, using the information obtained during the initialisation stage, the markings are matched against the data obtained during the initialisation stage, and are used to obtain and display the quantity information corresponding the floor selected. A sample display is shown is FIG. 13. Typically, the quantities are displayed in the units of mass (here in kilograms) as shown in FIG. 13. However, they may be displayed in other ways, such as in the number of pieces.

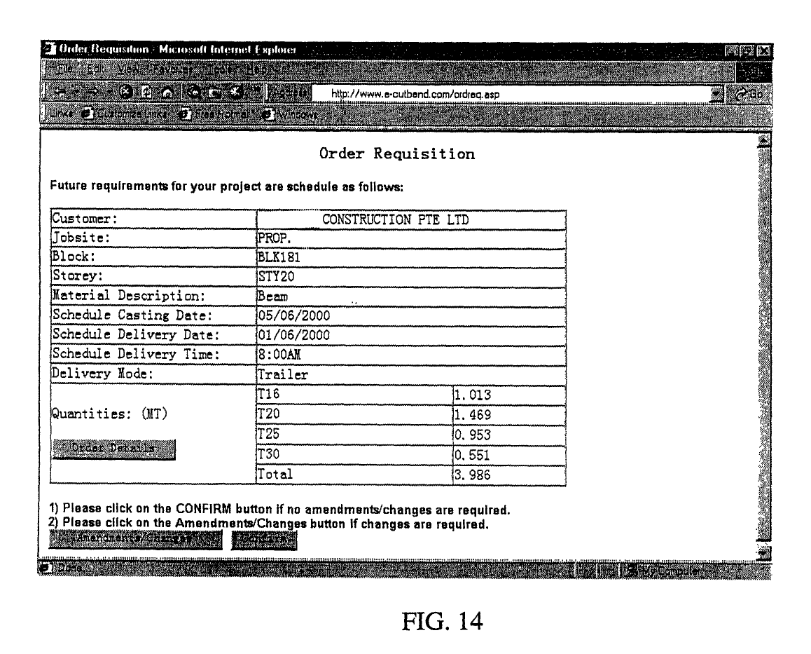

Once the quantity is extracted, the quantity information can be made available to the contractor 13 on a web page as a suggested order for which the contractor may choose to accept by confirming the order. A sample order requisition is shown in FIG. 14. The order requisition will typically include the customer/contractor's name (“Customer”), the name of the project or jobsite (“Jobsite”), the block number of the project (“Block”), the level or the story for which the order is being made (“Storey”), a summary of the material to be ordered which can be shown in detail (“Material Description”), the date the floor will be casted or built (“Schedule Casting Date”), the date the material will be delivered (“Schedule Delivery Date”), the time the material will be delivered (“Schedule Delivery Time”), the mode of delivery “Delivery Mode”), and the quantity information “Quantities”. While the quantities may be displayed in many forms, here they are displayed in metric tons corresponding to a particular marking, e.g., “T16”.

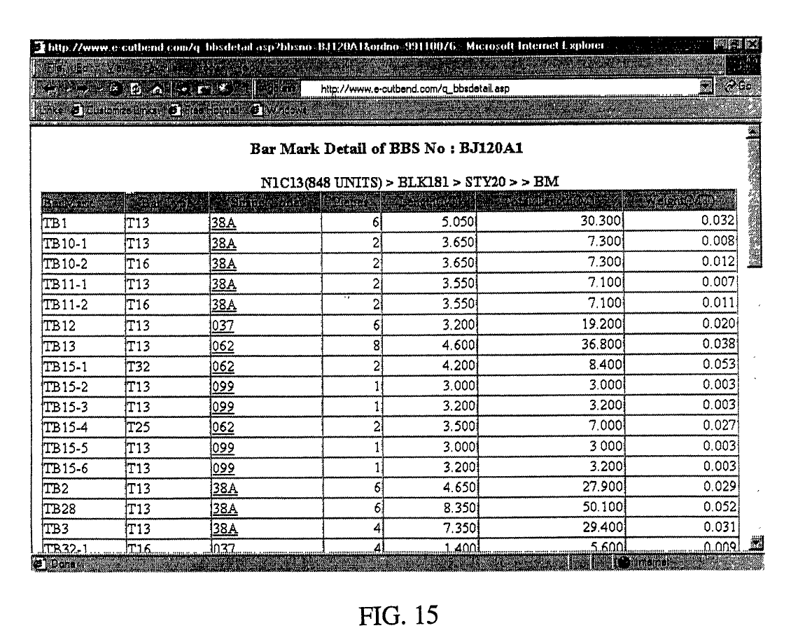

After the viewing, the order requisition may be confirmed by the contractor 13 by pressing the “confirm” button or changes can be made by pressing the “Amendments/Changes” button. Or if further details need to be reviewed, the “Order Details” button may pressed which will show a page as illustrated in FIG. 15. Once the order is confirmed, the order transaction is completed and the order information is stored in the order database 49 (FIG. 2) and the consolidated quantities database is updated to reflect the order.

The present method of transacting an order is efficient for many reasons. First, automatically extracting the quantity information from the construction drawings the details of an order can be prepared both quickly and without error. Second, by providing the order requisition from the material supplier to the contractor, the material supplier has some control over when and how orders are made such that the chances of having urgent or wrong orders are minimised. And third, by linking the ordering process to the progress database, orders can always be made at the most optimal time.

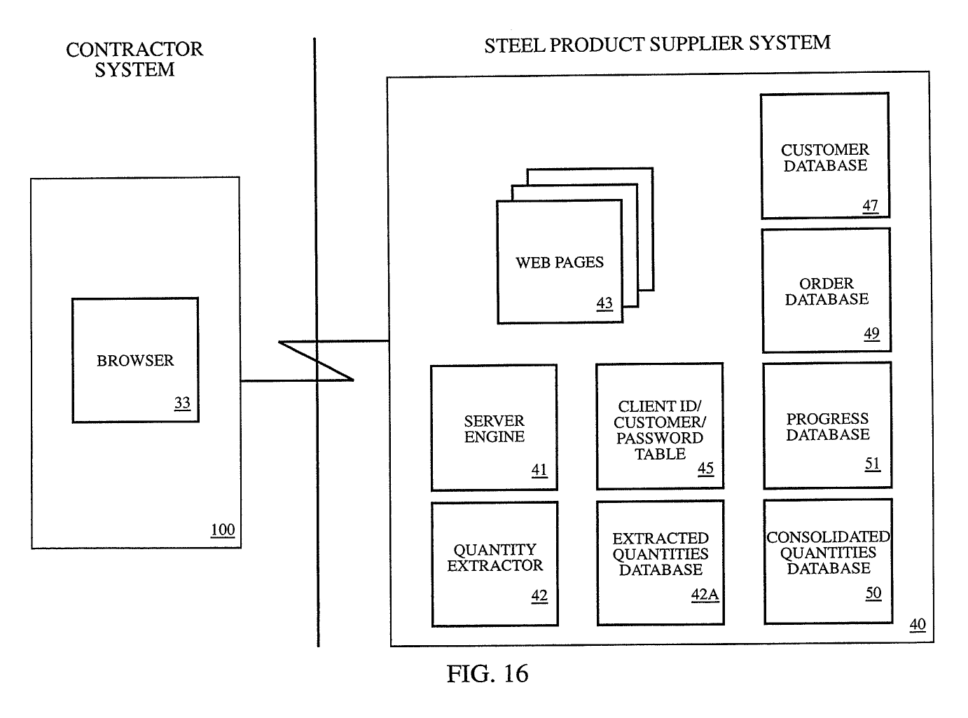

An alternative embodiment of the present invention is shown in FIG. 16. In the alternative embodiment, the project management system is not directly linked to the server system 40 (whether or not the dient system 100 is using it or not). Therefore, the project schedule information is relayed from the contractor 13 to the supplier 15 via some other means which can include e-mail, telephone, etc. Whichever manner the information is received, the supplier 15 inputs the information into the progress database 51. Any modification to the project schedule it receives from the contractor 13 is used to update the progress database 51 so that it always contains all of the up-to-date changes to the progress schedule.

The present invention may be embodied in other specific forms without departing from the spirit or essential characteristics thereof. For instance, although the present quantity extractor 42 was provided in a client/server system, it should be noted and appreciated by those skilled in the art, that it can be provided in any computer system as a separate module to extract quantity information from construction drawings. The presently disclosed embodiments are, therefore, to be considered in all respects as illustrative and not restrictive, the scope of the invention being indicated by the appended claims and all changes which come within the meaning and range of equivalency of the claims are, therefore, to be embraced therein.

We claim:

1. A method for efficiently transacting an order for a construction material between a construction contractor and a construction material supplier, said method comprising:
providing a construction material supplier's server system with a soft copy of a construction drawing;
automatically extracting quantity information from said drawing;
providing extracted quantity information in an order requisition to a construction contractors client system; and
providing an option to said client system to accept the order requisition.

2. The method as recited in claim 1 wherein said soft copy of the construction drawing contains a plan layout showing a type and location of structural elements in readable text, and a listing of the structural elements and the structural elements' corresponding specification in readable text.

3. The method as recited in claim 2 wherein said step of extracting quantity information for said order comprises the following steps:
opening said construction drawing and selecting said table in said construction drawing;
searching said table based on a predetermined set of guidelines and reading the text corresponding to said structural elements and structural elements' corresponding specification;
interpreting the text based on a pre-determined set of rules to calculate quantity information for said structural elements;
selecting said plan layout in said construction drawing;
searching said plan layout and reading the text marking said structural elements; and
calculating the quantity information for the order using said quantity information and said text marking said structural elements.

4. The method as recited in claim 1 further comprising a step of providing an option to said client system to modify the quantity information in said order requisition.

5. The method as recited in claim 3 further comprising a step of storing said quantity information for said structural elements in a database.

6. The method as recited in claim 3 further comprising a step of providing an option to said client system to modify the quantity information in said order requisition.

7. The method as recited in claim 5 further comprising a step of providing an option to said client system to modify the quantity information in said order requisition.

8. In a computer system, a method of automatically extracting quantity information from a construction drawing for an order for construction material, said construction drawing containing a plan layout marking a type and location of structural elements in readable text, and a table listing the structural elements and the structural elements' corresponding specification in readable text, said method comprising:
opening said construction drawing and selecting said table in said construction drawing;
searching said table based on a pre-determined set of guidelines and reading the text corresponding to said structural elements and structural elements' corresponding specification;
interpreting the text based on a pre-determined set of rules to calculate quantity information for said structural elements;
selecting said plan layout in said construction drawing;
searching said plan layout and reading the text marking said structural elements; and
calculating the quantity information for the order using said quantity information and said text marking said structural elements.

9. The method as recited in claim 8 further comprising a step of storing said quantity information for said structural elements in a database.

10. A method of efficiently communicating order information between a construction contractor and a construction material supplier, said method comprising:
providing a project schedule to construction material supplier's server system and storing said project schedule in a database;
determining a delivery schedule based on said project schedule and storing said delivery schedule in a database; and
providing a construction contractor's client system access to said project schedule and delivery schedule from said server system.

11. The method as recited in claim 10 further comprising:
automatically updating said project schedule stored in said server system when a change is made to a project schedule made in said client system; and
updating said delivery schedule based on said change made to said project schedule.

12. The method as recited in claim 1 wherein said server system and said client system is communicably linked through the internet.

13. The method as recited in claim 1 wherein said project schedule is developed using a scheduling management system.
